(19) United States
(12) Patent Application Publication
(10) Pub. No.: US 2024/0425205 A1
(43) Pub. Date: Dec. 26, 2024

(54) DEVICE FOR SECURING MOBILE INSPECTION MEANS TO OBJECTS TO BE INSPECTED

(71) Applicant: Lufthansa Technik AG, Hamburg (DE)

(72) Inventors: Jan Oke PETERS, Hamburg (DE); Michael THIES, Hamburg (DE); Thorsten SCHUEPPSTUHL, Hamburg (DE); Lukas BATH, Hamburg (DE); Lukas HOLTZ, Geesthacht (DE)

(21) Appl. No.: 18/748,137

(22) Filed: Jun. 20, 2024

(30) Foreign Application Priority Data
Jun. 23, 2023 (DE) 10 2023 116 571.2

(51) Int. Cl. B64F 5/60; B25J 5/00; B25J 15/08

(52) U.S. Cl. CPC B64F 5/60; B25J 5/007; B25J 15/08

(57) ABSTRACT

A device secures a mobile inspection robot to an aircraft engine. The mobile inspection robot is designed to insert a borescope into the aircraft engine to be inspected. The device includes: at least one positioning or orientation adjusting unit configured to adjust the position or orientation of the mobile inspection robot in relation to the aircraft engine to be inspected and at least one connector for providing a connection, which is rigid in at least one degree of freedom, between the mobile inspection robot and the aircraft engine to be inspected, in order to fix, in at least one degree of freedom, the relative position or orientation of the mobile inspection robot in relation to the aircraft engine to be inspected.

### CROSS REFERENCE TO RELATED APPLICATIONS

This application claims benefit to German Patent Application No. DE 10 2023 116 571.2, filed on Jun. 23, 2023, which is hereby incorporated by reference herein.

### FIELD

The present disclosure relates to a device for securing mobile inspection robots in the form of inspection means to objects to be inspected, in particular to aircraft engines.

### BACKGROUND

Borescopes are used for inspecting technical equipment or objects to be inspected in areas that are not directly visually accessible. The borescopes can be inserted into the regions of interest through small openings and offer a view of otherwise not visually accessible areas either directly using an optical unit or by displaying a video image recorded by a suitable sensor system at the borescope tip, also referred to as a video borescope.

Borescoping is used, for example, for inspecting aircraft engines, in order to look into the engine without it being necessary to expend time and effort on dismantling the engine for this. It is necessary (or at least desirable) to provide findings and document the area comprehensively at least for individual areas of the aircraft engine, such as the combustion chamber. In particular, it is desirable to be able to reproduce the documentation at different points in time of an object to be inspected, in order to be able to compare the results of inspections that took place at different times with one another directly.

In order to be able to document the interior of an object to be inspected as comprehensively and reproducibly as possible, auxiliary means may be used to guide a borescope provided for that purpose along a defined path inside the object to be inspected, with the result that the image data and/or other data collected by the borescope are recorded from defined positions inside the object to be inspected. For this, for example DE 10 2020 106 509 B3 discloses a mobile inspection robot for borescope inspection, during which an actuator element is used to systematically deform a repeatedly plastically deformable and elongated carrier element for the borescope and insert said carrier element into an object to be inspected in such a way that the free end of the carrier element and thus the borescope head is moved on a predefined path.

In order for the path predefined by the actuator element to also actually correspond to a desired path inside the object to be inspected, it is necessary for the actuator element to be arranged and aligned in a predefined position and orientation in relation to the object to be inspected. The initial position and orientation of the actuator element should preferably be maintained throughout the inspection operation, even if, for example in the case of the in situ inspection of aircraft engines mounted on an aircraft, the object to be inspected might be moved, for example owing to slight vibrations of the wing.

### SUMMARY

In an embodiment, the present disclosure provides a device secures a mobile inspection robot to an aircraft engine. The mobile inspection robot is designed to insert a borescope into the aircraft engine to be inspected. The device includes: at least one positioning or orientation adjusting unit configured to adjust the position or orientation of the mobile inspection robot in relation to the aircraft engine to be inspected and at least one connector for providing a connection, which is rigid in at least one degree of freedom, between the mobile inspection robot and the aircraft engine to be inspected, in order to fix, in at least one degree of freedom, the relative position or orientation of the mobile inspection robot in relation to the aircraft engine to be inspected.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 and FIG. 2 show schematic illustrations of an assembly for inspecting an aircraft engine;

FIG. 3 shows a schematic illustration of a first exemplary embodiment of a device according to the present disclosure;

FIG. 4 shows a schematic illustration of a second exemplary embodiment of a device according to the present disclosure; and

FIG. 5 shows a schematic illustration of a third exemplary embodiment of a device according to the present disclosure.

### DETAILED DESCRIPTION

Aspects of the present disclosure provide a device which can be used to maintain an initial position and/or orientation of a mobile inspection robot in relation to an object to be inspected.

The present disclosure relates to a device for securing mobile inspection robots in the form of inspection means to objects to be inspected, in particular to aircraft engines, the inspection robot being designed to insert a borescope into the object to be inspected, the device comprising at least one positioning and/or orientation adjusting unit for adjusting the position and/or orientation of the inspection means in relation to the object to be inspected and at least one connecting means for providing a connection, which is rigid in at least one degree of freedom, between the inspection means and the object to be inspected, in order to fix, in at least one degree of freedom, the relative position and/or orientation of the inspection means in relation to the object to be inspected.

The present disclosure has identifies that, for the inspection at least of certain objects to be inspected in certain inspection situations, such as in the case of the in situ inspection of aircraft engines, it is not ensured or cannot be ensured that the object to be inspected is stationary. Rather, the object to be inspected can be subject to at least relatively small movements. In the case of the in situ inspection of aircraft engines, it is possible for example for the wings, on which an aircraft engine is installed, to be made to vibrate owing to air movements or other maintenance and/or inspection work on the aircraft.

In order to still ensure that a borescope inserted by an inspection robot into the object to be inspected remains at a predefined position and/or on a predefined path, the present disclosure provides that the relative position and/or orientation of the inspection means in relation to the object to be inspected is fixed in at least one degree of freedom, specifically by virtue of a connection, which is rigid in the direction of this degree of freedom, between the inspection means and the object to be inspected, which connection is provided by a corresponding connecting means. In particular with regard to the one or more degrees of freedom to be fixed, the device also has at least one positioning and/or orientation adjusting unit for adjusting the position and/or orientation of the inspection means in relation to the object to be inspected. The at least one positioning and/or orientation adjusting unit makes it possible to adjust an initial position and/or orientation of the inspection means in relation to the object to be inspected, which initial position and/or orientation is then maintained in at least one degree of freedom owing to the connecting means, even in the event of movements of the object to be inspected.

The device according to the present disclosure is preferably designed such that the position and/or orientation of the inspection means in relation to the object to be inspected is maintained in all degrees of freedom by permanently fixing both the position and the orientation.

The present disclosure comprises two alternative embodiments in this respect.

In the first alternative embodiment, the connecting means is a suspension, which can be secured to the object to be inspected, for the inspection means. A corresponding suspension keeps the inspection means positionally and orientationally fixed relative to the object to be inspected, so that the inspection means does not move relative to the object to be inspected even in the event of movements of the object to be inspected. In principle, it is possible for a part of the mass of the inspection means to be carried by other means, such as supports or the like, at least provided that the described relative position and orientation of the inspection means in the event of expected movements of the object to be inspected is not changed as a result. However, it is preferred if the suspension is designed to completely carry the inspection means, with the result that other means for supporting the inspection means can be omitted.

In this case, it is preferred if the suspension comprises at least one positioning and/or orientation adjusting unit. By virtue of at least one positioning and/or orientation adjusting unit being part of the suspension, the inspection means can be positioned and/or aligned in relation to the object to be inspected to which it is connected via the suspension, this position and/or alignment then being permanently maintained even if the object to be inspected is moved.

In particular in the case of large and/or heavy inspection means, it can be provided that the suspension is secured at multiple spaced-apart securing points to the object to be inspected. As a result, the load acting on the object to be inspected owing to the suspension of the inspection means can be introduced into the object to be inspected in a manner distributed over it. In this case, it is also possible to use stay cables to provide a connection between the inspection means and securing points remote therefrom. The use of stay cables makes it possible to generally achieve a small packing size of the suspension in the unused state and a lower weight of the suspension in comparison with a for example rigid connection.

In an alternative embodiment variant, the device according to the present disclosure comprises a holding device for the inspection means having at least one positioning and/or orientation adjusting unit. In this case, the connecting means is a spacer, which can be fixedly connected both to the inspection means situated on the holding device and to the object to be inspected, the inspection means being flexibly mounted by the holding device in such a way that relative movements in at least one degree of freedom that are transmitted from the object to be inspected to the inspection means via the spacer are reproduced to a predefined extent by the inspection means. In the case of this embodiment variant, the inspection means is thus held and/or mounted separately from the object to be inspected; the connecting means, however, ensures that at least relatively small movements of the object to be inspected are also followed in at least one degree of freedom by the inspection means, so that the relative position between the inspection means and the object to be inspected remains the same with regard to the respective degree of freedom.

In order to enable a corresponding movement of the inspection means with the object to be inspected, the holding device preferably comprises suspension elements and/or damping elements. Corresponding suspension elements and/or damping elements make it possible to achieve a flexible mounting of the inspection means by the holding device, this flexible mounting allowing conjoint movement of the inspection means with the object to be inspected, at least in the event of relatively small movements.

In principle, it is preferred if the at least one positioning and/or orientation adjusting unit is designed such that a positional adjustment in at least two, preferably three non-parallel, preferably mutually perpendicular, directions in space and/or an orientational adjustment by at least two, preferably three non-parallel, preferably mutually perpendicular axes in space are/is possible.

To adjust the position of the inspection means in relation to the object to be inspected, a positioning adjusting unit can comprise components which are displaceable or telescopic along a rail. In particular, joints are suitable as orientation adjusting unit. The positioning and/or orientation adjusting unit(s) preferably can be fixed. For easier adjustment, positioning and/or orientation adjusting unit(s) can comprise scales or the like.

It is preferred if the device comprises a jig which preferably can be optionally secured thereto and which is designed to adjust the positioning and/or orientation adjusting unit independently of the inspection means in such a way that, after being secured to the device, the inspection means assumes the desired position and/or orientation in relation to the object to be inspected. The jig may also remain on the device after the inspection means has been secured to the device. As an alternative, the jig is removed after the positioning and/or orientation adjusting unit has been adjusted and before the inspection means is secured to the device.

It is preferred if the device according to the present disclosure is used with a mobile inspection robot, as known for example from DE 10 2020 106 509 B3. What is thus preferred is an assembly comprising a device according to the present disclosure and an inspection means which preferably can be optionally secured thereto, the inspection means being a mobile inspection robot for borescope inspection, during which an actuator element is used to systematically deform a repeatedly plastically deformable and elongated carrier element for the borescope and insert said carrier element into an object to be inspected, in such a way that the free end of the carrier element and thus the borescope head is moved on a predefined path. For further explanation of the mobile inspection robot, reference is made to the disclosure of DE 10 2020 106 509 B3.

The device according to the present disclosure and/or the assembly according to the present disclosure are preferably used to inspect aircraft engines as object to be inspected. In particular, the inspection of aircraft engines can take place in situ, which is to say in the state mounted on the aircraft.

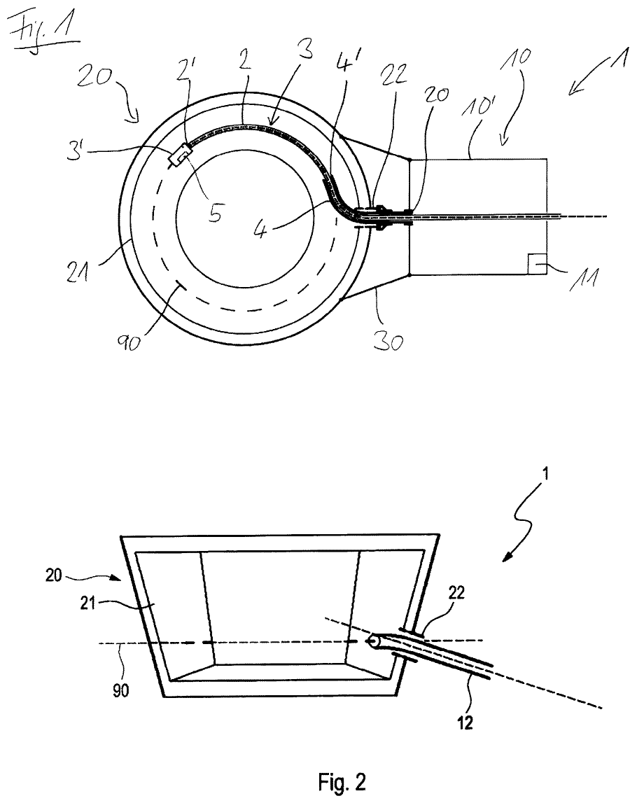

FIGS. 1 and 2 schematically outline a mobile inspection robot 10 as inspection means 1 for borescope inspection of an object 20 to be inspected, specifically the combustion chamber 21 of an aircraft engine. For the sake of clarity, only the combustion chamber 21 of the aircraft engine is illustrated here. The device according to the present disclosure can, however, be used in particular when the combustion chamber 21 is incorporated in an aircraft engine.

The mobile inspection robot 10 comprises a repeatedly plastically deformable, elongated carrier element 2 with a borescope head 3′ at that end 2′ which is inserted into the combustion chamber 21. The carrier element 2 and the borescope head 3′ ultimately form a borescope 3. The carrier element 2 is a material composite tube comprising a core of longitudinally coiled aluminium strip, an outer sheath made of polyethylene, and a protective film as protective covering on the inner side. The carrier element 2 is self-supporting, or also carries the borescope head 3′, with the result that it fundamentally keeps its shaping obtained after a plastic deformation without external influences.

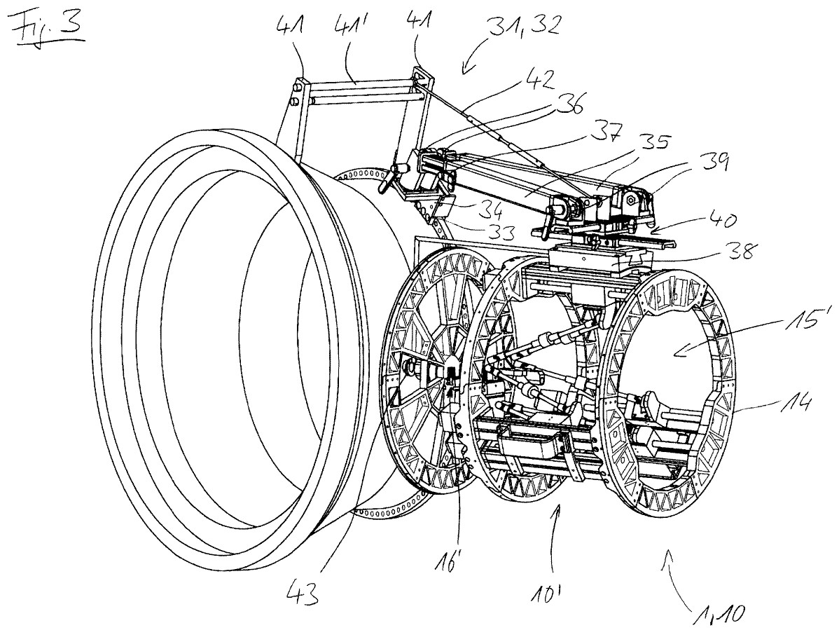

The carrier element 2 is guided by a deformation unit 10′, the precise design of which will be described in more detail below with reference to FIGS. 3 to 5. In the deformation unit 10′, the carrier element 2 is flexurally and torsionally deformed in controlled fashion by a control device 11, before it is routed out at the outlet end 12 of the deformation unit 10′ and inserted into the combustion chamber 21. For this, the carrier element 2, in a bent guide tube 4 detachably secured to the outlet end 12, is inserted into the combustion chamber 21 through an inspection opening 22 and from that point, which is defined by the free end 4′ of the guide tube 4 and can be reached again reproducibly, is actually self-supporting. The reproducibility is in particular also achieved by a device 30 according to the present disclosure, by means of which the inspection means 1 or its deformation unit 10 is secured to the object 20 to be inspected in a clearly defined position and orientation in relation to the inspection opening 22. FIGS. 3 to 5 show various embodiment variants of the device 30 according to the present disclosure, which will be explained in more detail later on.

The borescope head 3′ is fixedly connected to the carrier element 2 and comprises image recording sensors for recording digital 2D images, so that ultimately it is a video borescope 3. A probe unit 5, which makes it possible to ascertain the position and orientation of the borescope head 3′, is integrated in the borescope head 3′. The information obtained by the probe unit 5 is made available to the control device 11 and flows into the controller of the deformation unit 10, with the result that it can be ensured that the borescope head 3′ fundamentally moves along a predefined path 90 when the carrier element 2 is being inserted into the combustion chamber 21. If deviations from this path 90 are found, the control device 11 can take countermeasures by suitably activating the deformation unit 10′.

FIGS. 3 to 5 each show a possible embodiment variant of the deformation unit 10′ of the inspection means 1. The deformation unit 10′ comprises a positionally fixed guide element 13, which forms the outlet end 12 of the deformation unit 10′ and enables the detachable securing of a guide tube 4 thereto (cf. FIG. 1), and an actuator element 14.

The actuator element 14 is designed for axially guiding the carrier element 2 and with an arresting means in the form of a two-finger gripper 16 on a hexapod robot 15′ that can be controlled by the control device 11, so that the position and location of the actuator element 14 can be changed in particular with respect to the guide element 13, with the result that, inter alia, flexural deformations of a carrier element 2 guided by the guide element 13 and the actuator element 14 are achieved.

In the case of the deformation unit 10′, an arresting device in the form of a two-finger gripper 16′ is also provided on the guide element 13. If a carrier element 2 is arrested by the two arresting devices 16, 16′ both in the guide element 13 and in the actuator element 14, torsional moments can be introduced into the carrier element 2 by suitable activation of the hexapod robot 15′. Alternating arresting in the arresting devices 16, 16′ makes it possible to push a carrier element 2 out of the outlet opening 12 of the deformation unit 10′ step by step.

The embodiment illustrated of the mobile inspection robot 10 is light enough to be carried by a person, the deformation unit 10′ having handles 18 for easy handling. The low weight also makes it possible to secure the mobile inspection robot 10 or the inspection means 1 to an object 20 to be inspected by a borescope, such as an aircraft engine or parts thereof, without problems and in any desired location.

In FIG. 3, the inspection means 1, which is to say the mobile inspection robot 10 and in particular its deformation unit 10′, is secured to the object 20 to be inspected by means of a first embodiment variant of a device 30 according to the present disclosure.

The device 30 comprises a suspension 32, secured to the object to be inspected, as connecting means (also referred to herein as a connector) 31, which completely carries the inspection means 1. In other words, all the weight forces of the inspection means 1 are taken up by the suspension 32 and introduced into the object 20 to be inspected.

For this, the suspension 32 comprises a two-armed extension arm 35 secured at a first securing point 33 to the object 20 to be inspected via a securing means 34. The extension arm 35 is connected to the securing means 34 via a joint 36, which can be fixed if required, in such a way that it can be adjusted in terms of elevation and azimuth. The arms of the extension arm 35 are telescopic and thus longitudinally adjustable, with fixing means 37 for fixing an adjusted length being provided. At the end of the extension arm remote therefrom, a connecting element 38 for securing the inspection means 1 thereto is provided. The connecting element 38 is attached to the arms of the extension arm 35 via an optionally fixable joint 39, and is thus pivotable. Moreover, the connecting element 38 comprises linear sliding guides 40, which—together with the telescopic extension arm 35—make it possible to adjust the position of an inspection means 1 secured to the connecting element 38 in relation to the object 20 to be inspected. In interaction with the joints 36, 39 at the two ends of the extension arm 35, the inspection means 1 can be adjusted in terms of its position and orientation in relation to the object 20 to be inspected. The joints 36, 39 of the telescopic extension arm 35 and the linear sliding guides 40 thus form positioning and orientation adjusting units, which make it possible to position the inspection means in all spatial directions and to orient the inspection means at least in terms of elevation and azimuth.

In order to better introduce the weight of the inspection means 1 into the object 20 to be inspected, the suspension 32 is connected to the object 20 to be inspected not only via the securing means 34 at the securing point 33. Rather, another holder 41, which is secured to the object to be inspected 20 remotely from the one securing point 33, has transverse members 41′ and from which a longitudinally adjustable stay cable 42 is guided to the free end of the extension arm 35, is provided. The stay cable 42 may take up a portion of the weight force introduced by the inspection means 1 and introduce it via the holder 41 into the object 20 to be inspected. Owing to the longitudinal adjustability of the stay cable 42, the position and orientation adjustability of the suspension 32 is not adversely affected-rather, the stay cable 42 can be adapted to the length required for the desired position and orientation.

A jig 43 is also provided on the connecting element 37. The jig 43 specifies the position and orientation of that point of the inspection means 1—in this case the guide element 13 at the outlet end 12 of the deformation unit 10′—that is relevant for the correct insertion of the borescope 3 into the object 20 to be inspected, and does so detached from the inspection means 1 and thus even when the inspection means 1 is not yet attached to the connecting element 37, with the result that the position and orientation adjustment of the device 30 can be aligned already without an inspection means 1 being secured thereto, such that the inspection means 1 is directly and correctly aligned and positioned after it has been secured to the device 30.

The jig 43 can, as illustrated in FIG. 3, also remain mounted on the connecting element 37 after the inspection means 1 has been secured to the device 30. However, it is also possible for the jog 43 to be removed before the inspection means 1 is secured to the device 30.

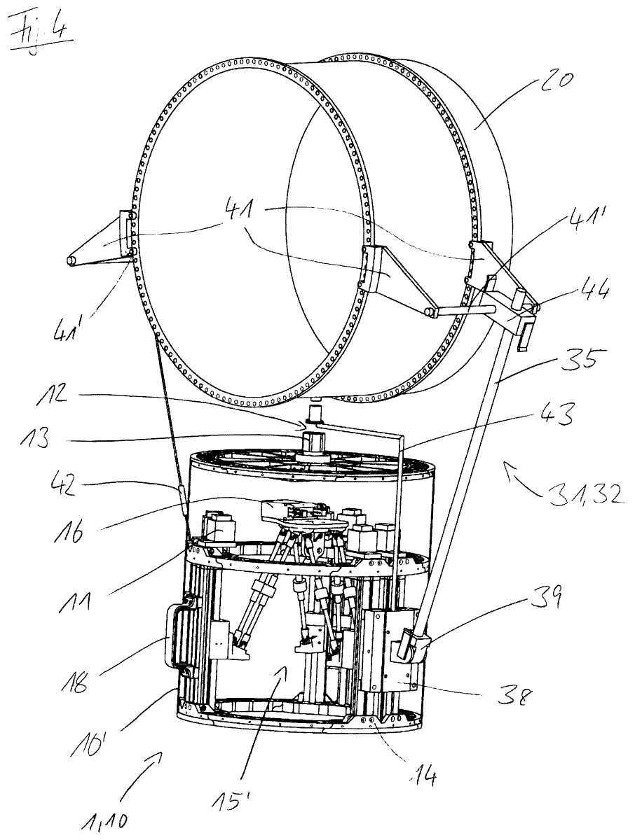

FIG. 4 shows a second embodiment variant of a device 30 according to the present disclosure, specifically again a suspension 32 as connecting means 31, by means of which an inspection means 1 is secured to the object 20 to be inspected. The inspection means 1 is identical to that in FIG. 3. The device 30 in FIG. 4 is also largely similar to that in FIG. 3, which is why reference is made to the statements made above and only the differences will be discussed below.

In the exemplary embodiment in FIG. 4, the extension arm 35 of the suspension 32 comprises a single rigid extension arm 35, which is secured to the transverse member 41′ of a first holder 41 via a connecting element 44. The connecting element 44 is displaceable on and pivotable about the transverse member 41′, albeit it can be fixed in terms of both movements. Moreover, the extension arm 35 can be displaced through the connecting element 44 and fixed at a desired position. A joint 39, which can be fixed as required and on which a connecting element 38 is arranged, is provided at the free end of the extension arm 35. The connecting element 44 and the joint 39 make it possible to adjust the inspection means 1 in terms of position and orientation in relation to the object 20 to be inspected. As means for adjusting the device 30—as already known from the exemplary embodiment according to FIG. 3—a jig 43, which can be removed as required, is provided.

The device 30 also comprises a stay cable 42, which is tensioned from another holder 41 or its transverse strut 41′. The stay cable 42, however, does not engage on the extension arm 35 itself, but rather is directly connected to the inspection means 1. Nevertheless, via the suspension 32 and the stay cable 42, all the weight forces of the inspection means 1 are taken up and introduced into the object 20 to be inspected. Consequently, once a position and orientation of the inspection means 1 in relation to the object 20 to be inspected has been adjusted, it is maintained, even if the object to be inspected should move.

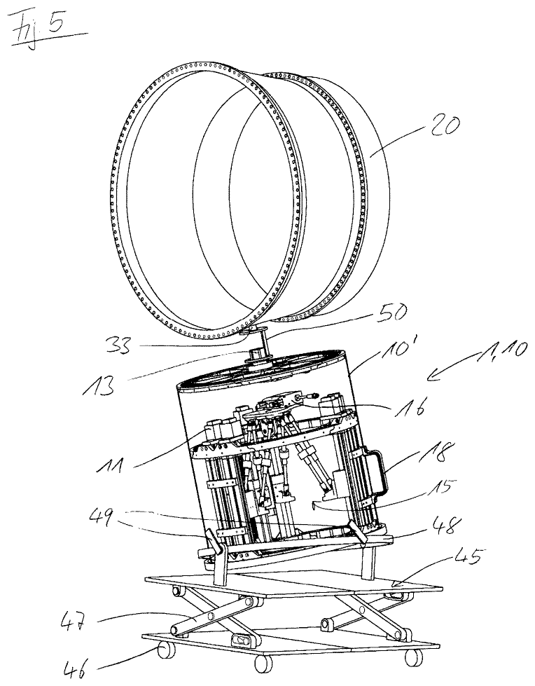

FIG. 5 shows a third embodiment variant of a device 30 according to the present disclosure for securing an inspection means 1—specifically the mobile inspection robot 10 already known from the previous figures—to an object 20 to be inspected. This embodiment variant is an alternative to the embodiment variants according to FIGS. 3 and 4.

The device 30 comprises a holding device (also referred to herein as a holder) 45 for the inspection means 1. In addition to floor rollers 46, which make it possible to freely position the entire holding means 45 in a plane parallel to the base and align it in terms of the azimuth, the holding device 45 also comprises a height adjusting means 47 for adjusting the position perpendicular to the base. A cardanic mounting 48 for the inspection means 1 is also provided and can be used to adjust the orientation of the inspection means 1. The joints of the cardanic mounting 48 can be fixed in principle by fixing means 49, the floor rollers 46 and the height adjusting means 47 by comparable elements, so that an adjusted position and orientation of the inspection means 1 is maintained at least without an external action of force. At the same time, the fixing means 49 or the comparable elements of the holding device 45 are flexible, such that an inspection means 1 held thereby can be moved to a respective predefined extent in the various degrees of freedom predefined by the holding device 45 if a force is made to act on the inspection means. For this, suitable suspension and damping elements are provided.

The device 30 also comprises a spacer 50 as connecting means 31. On the one side and at a securing point 33, the spacer 50 is fixedly connected to the object 20 to be inspected. The securing point 33 may be, for example, a borescope opening in the object 20 to be inspected, through which the borescope 3 of the mobile inspection robot 10 is to be inserted. On the other side, the spacer 50 is fixedly connected to the inspection means 1, in the exemplary embodiment illustrated to the guide element 13 of the deformation unit 10′.

Owing to the spacer 50 and the “flexibility” of the holding device 45, it is ensured that the inspection means 1 can also follow relatively small movements of the object to be inspected, without the relative position and orientation of the inspection means 1 and the object 20 to be inspected being changed.

The foregoing also directly results in the assembly according to the present disclosure comprising a device 30 according to the invention and an inspection means 1, as described in particular in connection with FIG. 1, which preferably can be optionally secured thereto.

The same holds true for the use of the device 30 and of the assembly comprising the device 30 in the event of inspecting aircraft engines or parts thereof as object 20 to be inspected.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for securing a mobile inspection robot to an aircraft engine, the mobile inspection robot being designed to insert a borescope into the aircraft engine to be inspected, the device comprising:
at least one positioning or orientation adjusting unit configured to adjust the position or orientation of the mobile inspection robot in relation to the aircraft engine to be inspected and at least one connector for providing a connection, which is rigid in at least one degree of freedom, between the mobile inspection robot and the aircraft engine to be inspected, in order to fix, in at least one degree of freedom, the relative position or orientation of the mobile inspection robot in relation to the aircraft engine to be inspected.

2. The device as claimed in claim 1, wherein:
the connector is a suspension, which is securable to the aircraft engine to be inspected, for the mobile inspection robot.

3. The device as claimed in claim 2, wherein:
the suspension comprises the at least one positioning or orientation adjusting unit.

4. The device as claimed in claim 2, wherein:
the suspension is configured to be secured at multiple spaced-apart securing points to the aircraft engine to be inspected, at least one connection between the mobile inspection robot and a securing point comprising a stay cable.

5. The device as claimed in claim 1, wherein:
the device further comprises a holder for the mobile inspection robot comprising the at least one positioning or orientation adjusting unit and the connector is a spacer, which is configured to be fixedly connected both to the mobile inspection robot situated on the holder and to the aircraft engine to be inspected, the mobile inspection robot being flexibly mounted by the holder in such a way that relative movements in at least one degree of freedom that are transmitted from the aircraft engine to be inspected to the mobile inspection robot via the spacer are reproduced to a predefined extent by the mobile inspection robot.

6. The device as claimed in claim 5, wherein:
the holder comprises suspension elements or damping elements that are configured to flexibly mount the mobile inspection robot by way of the holder.

7. The device as claimed in claim 1, wherein:
the at least one positioning or orientation adjusting unit is designed such that a positional adjustment in at least two directions in space or an orientational adjustment by at least two axes in space is possible.

8. The device as claimed in claim 1, wherein:
at least one positioning adjusting unit comprises components which are displaceable or telescopic along a rail or at least one orientation adjusting unit comprises a joint.

9. The device as claimed in claim 1, wherein:
the device further comprises a jig which is designed to adjust the positioning or orientation adjusting unit independently of the mobile inspection robot in such a way that, after being secured to the device, the mobile inspection robot assumes the desired position or orientation in relation to the aircraft engine to be inspected.

10. An assembly comprising the device as claimed in claim 1 and the mobile inspection robot, wherein
the mobile inspection robot is a mobile inspection robot for borescope inspection, during which an actuator element is used to systematically deform a repeatedly plastically deformable and elongated carrier element for the borescope and insert the carrier element into an aircraft engine to be inspected, in such a way that the free end of the carrier element and thus the borescope head is moved on a predefined path.

11. The device as claimed in claim 2, wherein:
the suspension is configured to completely carry the mobile inspection robot.
